(19) United States
(12) Patent Application Publication
(10) Pub. No.: US 2026/0322660 A1
(43) Pub. Date: Oct. 15, 2026

(54) ADAPTIVE EQUALIZER AND OPERATING METHOD THEREOF

(71) Applicant: HIMAX TECHNOLOGIES LIMITED, Tainan City (TW)

(72) Inventors: Liang-Yu Chien, Tainan City (TW); YuShyang Huang, Tainan City (TW)

(73) Assignee: HIMAX TECHNOLOGIES LIMITED, Tainan City (TW)

(21) Appl. No.: 19/356,177

(22) Filed: Oct. 12, 2025

Related U.S. Application Data
(60) Provisional application No. 63/788,144, filed on Apr. 14, 2025.

(51) Int. Cl. H04L 25/03; H04L 7/04

(52) U.S. Cl. CPC H04L 25/03057; H04L 7/04

(57) ABSTRACT

An adaptive equalizer and the operation method thereof are provided. The adaptive equalizer includes an equalizing circuit, a decoder and an adaptive equalizing module. Based on a plurality of eye width gears and a plurality of eye height gears, the equalizing circuit generates recovery signal data according to a receiving signal. The decoder is coupled to the equalizing circuit. The decoder generates error count data according to the recovery signal data and correct bit data corresponding to the receiving signal. The adaptive equalizing module is coupled to the decoder and the equalizing circuit. The adaptive equalizing module generates an output eye width gear and an output eye height gear according to the error count data, such that the equalizing circuit compensates channel loss based on the output eye width gear and the output eye height gear.

### CROSS-REFERENCE TO RELATED APPLICATIONS

This application claims the priority benefit to U.S. provisional patent application no. 63/788,144, filed on Apr. 14, 2025. The entirety of the above-mentioned patent application is hereby incorporated by reference herein and made a part of this specification.

### BACKGROUND

### Technical Field

This disclosure relates to an equalizer, and in particular to an adaptive equalizer applied in a receiver.

### Description of Related Art

FIG. 1 is a schematic diagram of operations of a conventional equalizer. Referring to FIG. 1, the equalizer may be adaptive to a receiver. In general, the equalizer may compensate channel loss by a continuous-time linear equalizer (CTLE). Due to different cables, the received signals RX1-RX4 have different channel loss. The CTLE may compensate the received signals RX1-RX4 with one matched gear of the gears G01-G016. Each of the gears G01-G016 indicates a difference between a high frequency gain FH and a low frequency gain FL, and further indicates a compensation capability. For example, the received signal RX1 is compensated with the matched gear G02 to be recovered as the eye diagram with well peaking. The received signal RX4 is compensated with the matched gear G16 to be recovered as the eye diagram with well peaking. On the other hand, the received signal RX1 is compensated with the unmatched gear G010 to be recovered as the eye diagram with over peaking. The received signal RX4 is compensated with the unmatched gear G011 to be recovered as the eye diagram with under peaking.

However, the conventional equalizer merely provides a few gears to be selected as the matched gear. During the selection, the conventional equalizer is external to an oscilloscope, and outputs eye diagrams with the foresaid gears respectively to the oscilloscope. The matched gear is selected manually according to the eye diagrams shown in the oscilloscope. As such, the conventional equalizer cannot select the matched gear automatically, and cannot select the matched gear with a high accuracy and a high efficiency.

### SUMMARY

Embodiments of the disclosure provide and adaptive equalizer, adaptive to a receiver, and capable of automatically and accurately set a matched gear.

The adaptive equalizer of the embodiment of the disclosure includes an equalizing circuit, a decoder and an adaptive equalizing module. The equalizing circuit is configured to, based on a plurality of eye width gears and a plurality of eye height gears, generate recovery signal data according to a receiving signal. The decoder is coupled to the equalizing circuit. The decoder is configured to generate error count data according to the recovery signal data and correct bit data corresponding to the receiving signal. The adaptive equalizing module is coupled to the decoder and the equalizing circuit. The adaptive equalizing module is configured to generate an output eye width gear and an output eye height gear according to the error count data, such that the equalizing circuit compensates channel loss based on the output eye width gear and the output eye height gear.

The embodiment of the disclosure further provides an operating method of an adaptive equalizer. The operating method includes the following steps. Based on a plurality of eye width gears and a plurality of eye height gears, an equalizing circuit generates recovery signal data according to a receiving signal. A decoder generates error count data according to the recovery signal data and correct bit data corresponding to the receiving signal. An adaptive equalizing module generates an output eye width gear and an output eye height gear according to the error count data, such that the equalizing circuit compensates channel loss based on the output eye width gear and the output eye height gear.

Based on the above, in the adaptive equalizer and the operation method thereof of the embodiment of the disclosure, by decoding the recovery signal data corresponding to various gears with the correct bit data through the decoder, the generated error count data includes correct bits and error bits corresponding to the eye width gears and the eye height gears. By generating the output gears regarding the eye width and the eye height according to the error count data through the adaptive equalizing module, the adaptive equalizer is capable of automatically and accurately obtaining the matched gear, and further improves the efficiency of gear setting for compensating the channel loss.

To make the aforementioned more comprehensible, several embodiments accompanied with drawings are described in detail as follows.

### BRIEF DESCRIPTION OF THE DRAWINGS

The accompanying drawings are included to provide a further understanding of the disclosure, and are incorporated in and constitute a part of this specification. The drawings illustrate example embodiments of the disclosure and, together with the description, serve to explain the principles of the disclosure.

FIG. 1 is a schematic diagram of operations of a conventional equalizer.

FIG. 2 is a circuit block diagram of an adaptive equalizer according to an embodiment of the disclosure.

FIG. 3 is a flow charts of an operating method of an adaptive equalizer according to an embodiment of the disclosure.

FIG. 4A is a schematic diagram of operations of a continuous-time linear equalizer (CTLE) according to the embodiment of FIG. 2 of the disclosure.

FIG. 4B is a schematic diagram of operations of an offset circuit according to the embodiment of FIG. 2 of the disclosure.

FIG. 5 is a schematic diagram of operations of an American national standards institute (ANSI) decoder according to the embodiment of FIG. 2 of the disclosure.

FIG. 6 is a schematic diagram of operations of an adaptive equalizing module according to the embodiment of FIG. 2 of the disclosure.

FIGS. 7A and 7B are flow charts of an operating method of the adaptive equalizing module according to the embodiment of FIG. 6 of the disclosure.

FIG. 8 is a schematic diagram of operations of an adaptive equalizing module according to the embodiment of FIG. 2 of the disclosure.

FIGS. 9A and 9B are flow charts of an operating method of the adaptive equalizing module according to the embodiment of FIG. 8 of the disclosure.

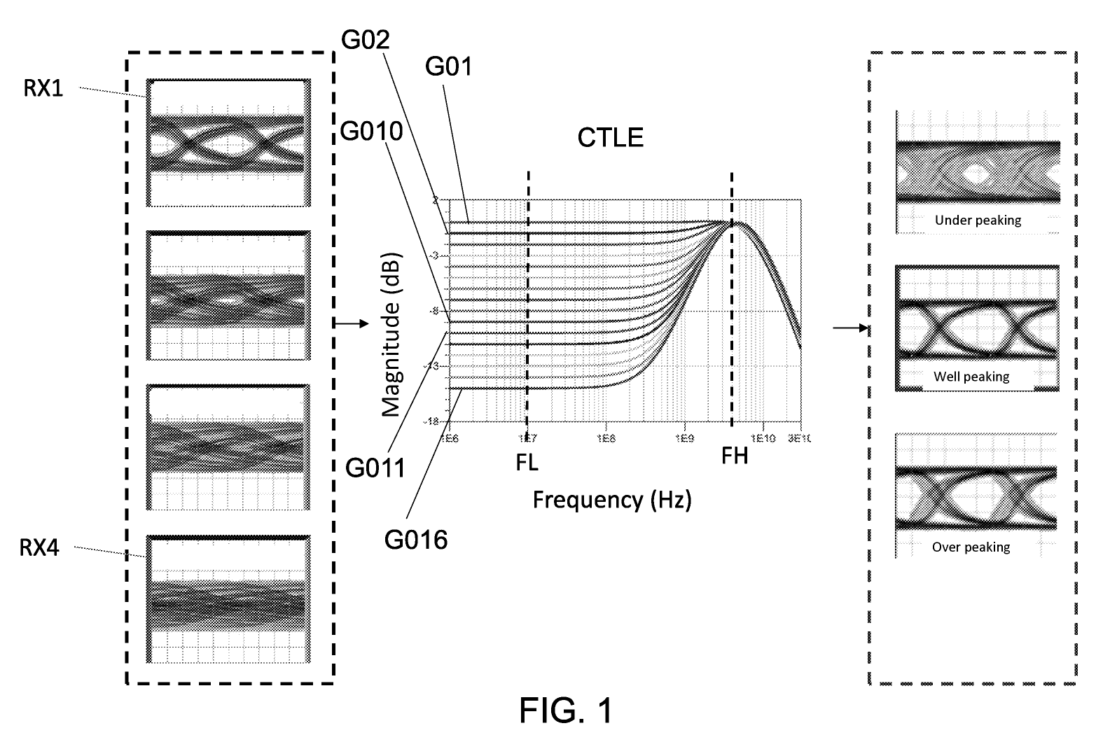

### BRIEF DESCRIPTION OF THE DRAWINGS

Some embodiments of the disclosure will be described in detail below with reference to the accompanying drawings. The reference numerals cited in the following description will be regarded as the same or similar elements when the same reference numeral appears in different drawings. These embodiments are only part of the disclosure and do not disclose all possible implementations of the disclosure. Rather, these embodiments are merely examples within the scope of the disclosure.

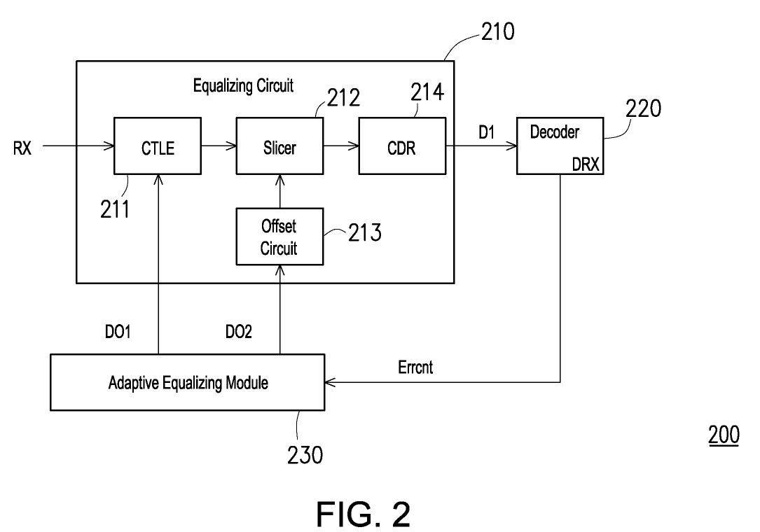

FIG. 2 is a circuit block diagram of an adaptive equalizer according to an embodiment of the disclosure. Referring to FIG. 2, an adaptive equalizer 200 may be adaptive to a receiver. The adaptive equalizer 200 is capable of automatically and accurately set a matched gear without an oscilloscope. The adaptive equalizer 200 is capable of compensating channel loss of a signal received by the receiver with the matched gear to output a data signal with well peaking. The matched gear includes multiple gears DO1-DO2 associated with an eye width and an eye height.

In the embodiment of FIG. 2, the adaptive equalizer 200 includes an equalizing circuit 210, a decoder 220, and an adaptive equalizing module 230. The equalizing circuit 210 is coupled to a cable (not shown) to receive a receiving signal RX. In a process for finding the matched gear, the receiving signal RX includes a specific pattern for detecting the matched gear, for example, Pseudorandom binary sequence.

The equalizing circuit 210 is further coupled to the decoder 220 and the adaptive equalizing module 230. The decoder 220 is coupled to the adaptive equalizing module 230. The decoder 220 may be implemented by multiple logical circuits to implement sweeping, decoding and various calculation functions. The adaptive equalizing module 230 may be implemented by multiple logical circuits to implement initializing, storing, and various calculation functions.

In this embodiment, the equalizing circuit 210 includes a continuous-time linear equalizer (CTLE) 211, a slicer 212, an offset circuit 213, and a clock and data recovery (CDR) circuit 214, wherein the CDR 214 may be a digital CDR (i.e., DCDR). The CTLE 211 is coupled to the adaptive equalizing module 230. The slicer 212 is coupled to the CTLE 211 and the offset circuit 213, and the offset circuit 213 is further coupled to the adaptive equalizing module 230. The CDR 214 is coupled to the slicer 212 and the decoder 220.

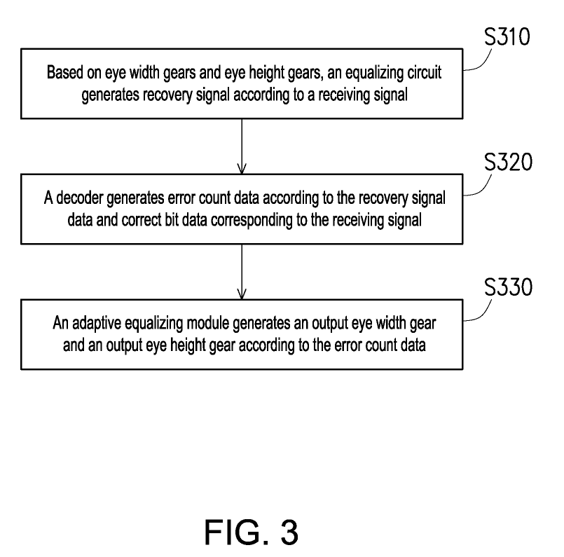

FIG. 3 is a flow charts of an operating method of an adaptive equalizer according to an embodiment of the disclosure. Referring to FIGS. 2 and 3, the adaptive equalizer 200 executes steps S310 to S330 to set a matched gear including the gears DO1 and DOU2. The matched gear indicates a compensation ability for the channel loss. The steps S310 to S330 may be executed in an initialization of the adaptive equalizer 200, or before the adaptive equalizer 200 being utilized in practical application.

In a step S310, based on a plurality of eye width gears and a plurality of eye height gears, the equalizing circuit 210 generates recovery signal data D1 according to a receiving signal RX. The receiving signal RX may be, for example, a known testing signal. The recovery signal data D1 may be, for example, multiple eye diagrams which have been linearly equalized by the eye width gears and the eye height gears respectively.

In detail, the CTLE 211 receives the receiving signal RX. The CTLE 211 compensates the high frequency gain of the receiving signal RX with the eye width gears respectively to output first signals (not shown). The slicer 212 determines data bits of the first signals output from the CTLE 211 according to a common mode voltage with the eye height gears respectively to output second signals (not shown). The eye height gears are provided from the offset circuit 213 as various decision thresholds. The CDR 214 recovers the data bits of the second signals output from the slicer 212 to output the recovery signal data D1.

In this embodiment, each of the eye width gears indicates a difference between a high frequency gain and a low frequency gain, and further indicates the compensation capability for the channel loss. Each of the eye width gears effects an eye width of the eye diagram. In addition, each of the eye height gears indicates a reference value of the common mode voltage, and further indicates a decision threshold for a modulation signal. Each of the eye height gears effects an eye height of the eye diagram.

In a step S320, the decoder 220 receives the recovery signal data D1. The decoder 220 generates error count data Errcnt according to the recovery signal data D1 and correct bit data DRX corresponding to the receiving signal RX. The correct bit data DRX is built in the decoder 220. The correct bit data DRX may be, for example, digital data corresponding to the known receiving signal RX, and is encoded by ANSI coding. The foresaid ANSI coding may be, for example, UTF-8, or other coding based on the design requirement.

Alternatively stated, the decoder 220 decodes multiple eye diagrams (i.e., the recovery signal data D1 corresponding to various eye width gears and the eye height gears) with the correct bit data DRX. The decoder 220 counts an amount of correct decoded bits to generate correct bits, and counts an amount of error decoded bits to generate error bits. As such, the error count data Errcnt includes the correct bits and the error bits corresponding to the eye width gears and the eye height gears.

In a step S330, the adaptive equalizing module 230 generates an output eye width gear DO1 and an output eye height gear DO2 according to the error count data Errcnt. The adaptive equalizing module 230 outputs these gears DO1 and DO2 to the equalizing circuit 210. Alternatively stated, the adaptive equalizing module 230 analyzes the error count data Errcnt to know a functional range that the equalizing circuit 210 may work and having no error bits. Based on the analyzed result, the adaptive equalizing module 230 calculates the output eye width gear DO1 as the matched gear for modulating the eye width, and calculates the output eye height gear DO2 as the matched gear for modulating the eye height.

The adaptive equalizing module 230 outputs the output eye width gear DO1 and the output eye height gear DO2 to the equalizing circuit 210. The CTLE 211 receives the output eye width gear DO1. The CTLE 211 sets the output eye width gear DO1 as an operating gear for the compensation. The offset circuit 213 receives the output eye height gear DO2. The offset circuit 213 sets the output eye height gear DO2 as the operating gear of the slicer 212 for the decision.

As such, the equalizing circuit 210 compensates the channel loss of any signals received by the adaptive equalizer 200 based on the output eye width gear DO1 and the output eye height gear DO2, to generate the corresponding data signal with well peaking.

It is worth mentioning that, since the recovery signal data D1 includes various eye diagrams corresponding to all candidate gears, by decoding and counting error decoded bits of the recovery signal data D1 with the correct bit data DRX through the decoder, the error count data Errcnt includes correct bits and error bits, and may be represented as various eye width gears and eye height gears. By calculating multiple gears DO1 and DO2 according to the error count data Errcnt through the adaptive equalizing module 230, the adaptive equalizer 200 automatically sets the matched gear of the CTLE 211 and the matched gear of the slicer 212. As such, the adaptive equalizer 200 is capable of automatically and accurately obtaining the matched gear including the foresaid gears DO1 and DO2, and further improves the efficiency of gear setting.

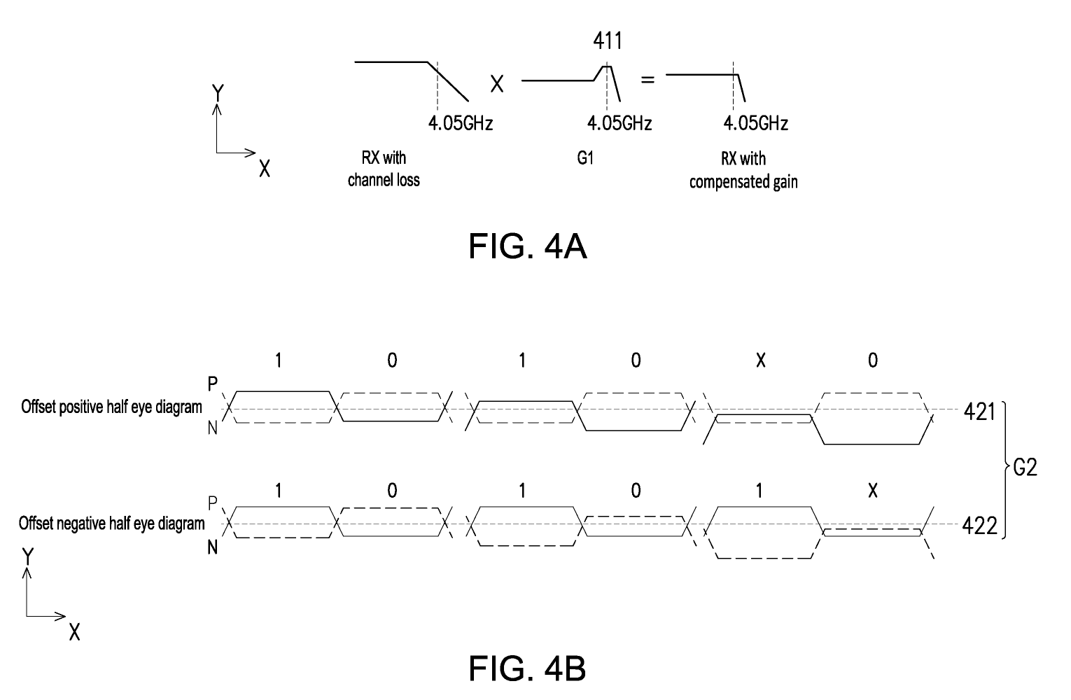

FIG. 4A is a schematic diagram of operations of a CTLE according to the embodiment of FIG. 2 of the disclosure. Referring to FIGS. 2 and 4A, the CTLE 211 receives the receiving signal RX with the channel loss. The CTLE 211 compensates the high frequency gain of the receiving signal RX with one of the eye width gears G1 to generate the first signal (i.e., the receiving signal RX with the compensated gain). The foresaid eye width gear may be, for example, correspond to a high frequency as 4.05 GHz.

By switching to another gear of the eye width gears G1, the CTLE 211 moves the reference line 411 along an x-axis to have different high frequency response. As such, the recovery signal data D1 includes overlapped eye diagrams with offset eye width gears G1 along the x-axis.

FIG. 4B is a schematic diagram of operations of an offset circuit according to the embodiment of FIG. 2 of the disclosure. Referring to FIGS. 2 and 4B, the slicer 212 decides data bits of the first signal output from the CTLE 211 with one of the eye height gears G2 to generate the second signal (i.e., the receiving signal RX with decision to be “0” or “1”). The foresaid eye height gear may be, for example, correspond to a positive half height between the top eye diagram and a reference line 421, or correspond to negative half height between the bottom eye diagram and a reference line 422.

To offset the positive half eye diagram, the offset circuit 213 offsets the recovery signal data D1 (i.e., a solid line P) relative to the reference line 421. Specifically, relative to the reference line 421, the offset circuit 213 sequentially, with various eye height gears G2, pulls down the solid line P along the y-axis. Based on a comparison between each solid line P with the reference line 421, the offset circuit 213 decides the recovery signal data D1 to be data bit “1” or data bit “0”.

It should be noted that, when the recovery signal data D1 (i.e., a solid line P) is pulled down to have data bits being not overlapped with reference line 421, the slicer 212 cannot decide these data bits from the solid line P with such eye height gear, and the CDR 213 cannot read these data bits accordingly. As such, the decoder 220 may determine such recovery signal data D1 have error decoded bits “X”. By making the offset circuit 213 do the wrong result on purpose, the decoder 220 marks the error bits as one limitation of the offset circuit 213. That is, the adaptive equalizer 200 knows the positive half height that the equalizing circuit 210 may work and having no error bits.

To obtain another half height (i.e., the negative half height) that the equalizing circuit 210 may work and having no error bits, the offset circuit 213 offsets the recovery signal data D1 (i.e., a solid line P) relative to the reference line 422. That is, relative to the reference line 422, the offset circuit 213 sequentially, with various eye height gears G2, pulls up the solid line P along the y-axis. Similar to the operations described regarding the positive half eye diagram, the offset circuit 213 decides the recovery signal data D1 to be data bit “1” or data bit “0”, and the decoder 220 may determine the recovery signal data D1 which has data bits being not overlapped with reference line 422 have error decoded bits “X”. As such, the adaptive equalizer 200 knows the negative half height that the equalizing circuit 210 may work and having no error bits. Based on the obtained positive half height and the negative half height, the adaptive equalizer 200 obtains the whole eye height that the equalizing circuit 210 may work and having no error bits.

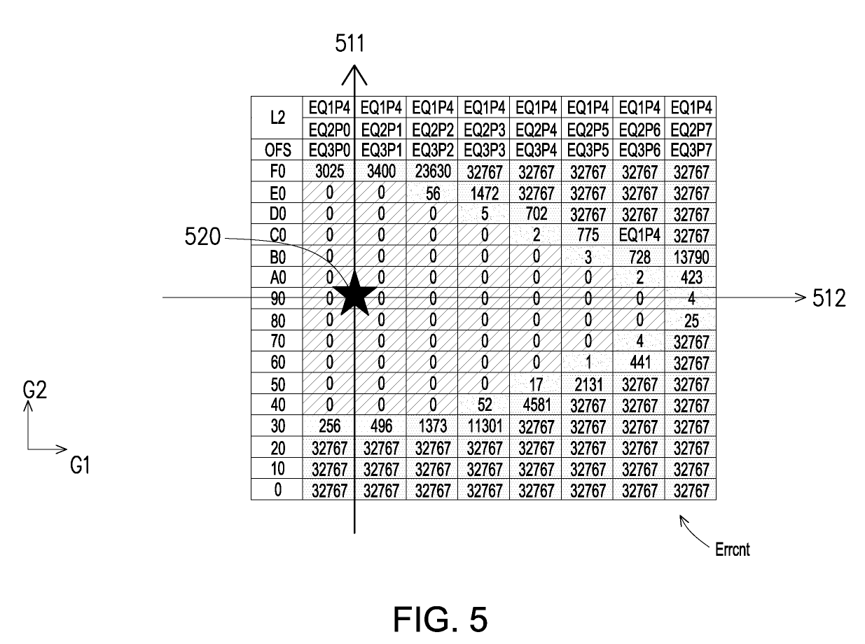

FIG. 5 is a schematic diagram of operations of a decoder according to the embodiment of FIG. 2 of the disclosure. Referring to FIGS. 2 and 5, a part (e.g., positive right half part) of the error count data Errcnt is illustrated. The error count data Errcnt may be represented as a two-dimensional diagram. In the error count data Errcnt, the X-axis may be, for example, the eye width gears G1, and the Y-axis may be, for example, the eye height gears G2.

The error count data Errcnt includes correct bits (i.e., bit “0”) and error bits (i.e., bit other than “0”). The correct bits indicate the amount of the correct decoded bits of the multiple eye diagrams with reference to the correct bit data DRX. The error bits indicate the amount of the error decoded bits of the eye diagrams with reference to the correct bit data DRX. These eye diagrams are the recovery signal data D1 corresponding to various eye width gears G1 and the eye height gears G2.

In this embodiment, the adaptive equalizing module 230 sweeps the recovery signal data D1 corresponding to the eye width gears G1 with each one of the eye height gears G2, to generate the output eye width gear DO1 and the output eye height gear DO2. Alternatively stated, the adaptive equalizing module 230 sweeps the eye width gears G1 with one fixed eye height gear to decode the corresponding data of the recovery signal data D1. Then, the adaptive equalizing module 230 sweeps the eye width gears G1 with another fixed eye height gear to operate similarly, until all data of the recovery signal data D1 is decoded, the adaptive equalizing module 230 calculates the output eye width gear DO1 and the output eye height gear DO2 according to these swept results.

It should be noted that, since the equalizing circuit 210 do wrong on purpose with all candidate gears G1 and G2, the decoder 220 counts the amounts of correct decoded bits and the error decoded bits, such that the counting result are represented as error/correct bits distribution with reference to the eye width gears G1 and the eye height gears G2. Therefore, the error count data Errcnt indicates the functional range (i.e., the range having the bits “0”) that the equalizing circuit 210 may work and having no error bits. In such range, each of the eye width gears G1 corresponding to the correct bit “0” indicates a functional gain difference of the CTLE 211. Each of the eye height gear G2 corresponding to the correct bit “0” indicates a functional common mode voltage and a reasonable decision threshold of the slicer 212.

Based on the error count data Errcnt, rather than the analog diagram, the adaptive equalizing module 230 is capable of automatically setting the output eye width gear DO1 and the output eye height gear DO2 where one position 520 is located. In detail, the adaptive equalizing module 230 sets plurality of edge eye width gears of the eye width gears G1, according to the error count data Errcnt. The adaptive equalizing module 230 sets a plurality of edge eye height gears of the eye height gears G2, according to the error count data Errcnt. The edge eye width gears may be, for example, the rightmost eye width gear and the leftmost eye width gear in the eye width gears G1. The edge eye height gears may be, for example, the top eye height gear and the bottom eye height gear in the eye height gears G2. Furthermore, the adaptive equalizing module 230 calculates the output eye width gear DO1 according to the edge eye width gears, and calculates the output eye height gear DO2 according to the edge eye height gears.

Alternatively, based on the error count data Errcnt, rather than the analog diagram, the adaptive equalizer 200 may provide a user to set or select the position 520 by scrolling the line 511 with the adjustable gears G2, and/or scrolling the line 512 with the adjustable gears G1. Without the oscilloscope, the user is capable of setting the reasonable gears DO1 and DO2 in a convenient and efficient way.

Alternatively, in this embodiment, the adaptive equalizing module 230 sweeps the recovery signal data D1 corresponding to the eye height gears G2 with each one of the eye width gears G1, to generate the output eye width gear DO1 and the output eye height gear DO2. Alternatively stated, the adaptive equalizing module 230 sweeps the eye height gears G2 with one fixed eye width gear to decode the corresponding data of the recovery signal data D1. Then, the adaptive equalizing module 230 sweeps the eye height gears G2 with another fixed eye width gear to operate similarly, until all data of the recovery signal data D1 is decoded, the adaptive equalizing module 230 calculates the output eye width gear DO1 and the output eye height gear DO2 according to these swept results.

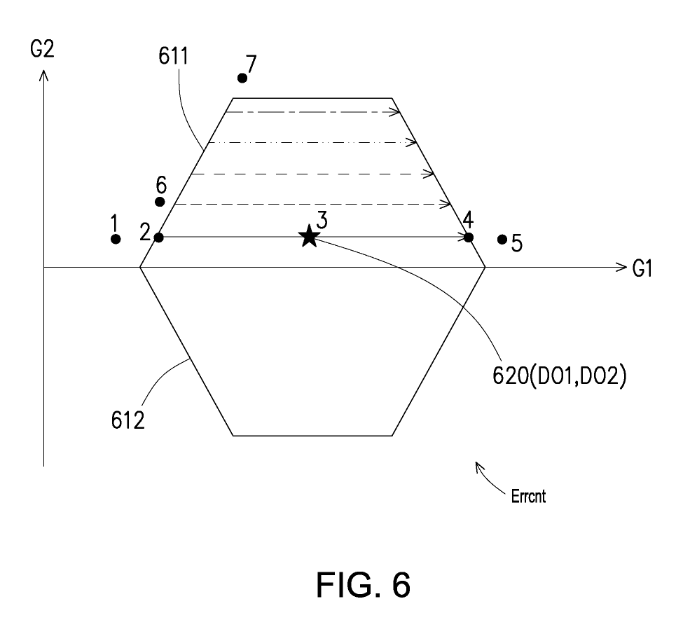

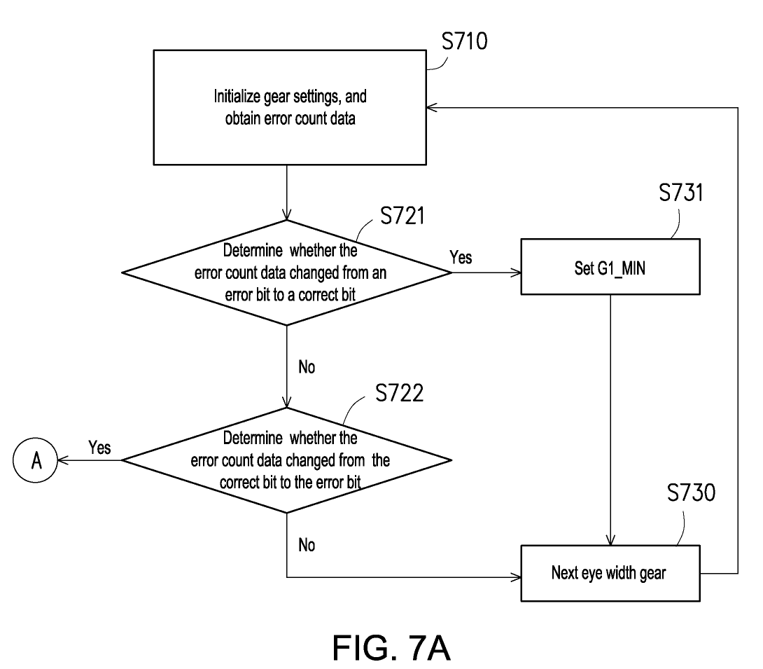

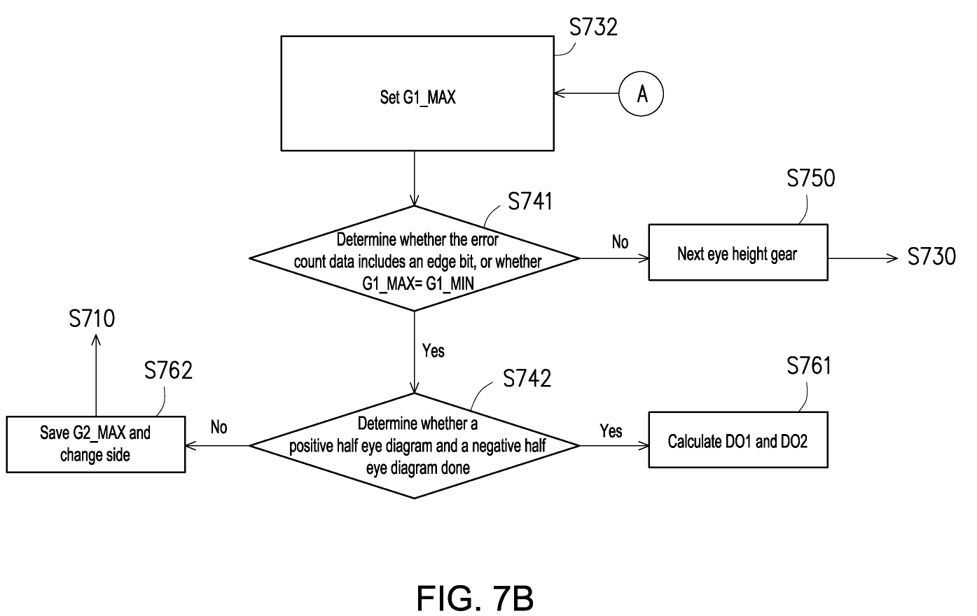

FIG. 6 is a schematic diagram of operations of an adaptive equalizing module according to the embodiment of FIG. 2 of the disclosure. FIGS. 7A and 7B are flow charts of an operating method of the adaptive equalizing module according to the embodiment of FIG. 6 of the disclosure. Referring to FIGS. 2, 6, 7A and 7B, the adaptive equalizer 200 executes steps S710 to S762 through the adaptive equalizing module 230 to calculate the output gears DO1 and DO2. In FIG. 6, the error count data Errcnt is exemplarily illustrated, with the x-axis reference to the eye width gears G1 and the y-axis reference to the eye height gears G2. The bits inside two frames 611 and 612 are assumed to be correct data bits which are equalized by the equalizing circuit 210. The bits outside the frames 611 and 612 are assumed to be error data bits which are equalized by the equalizing circuit 210.

In this embodiment, the adaptive equalizing module 230 analyzes the error count data Errcnt by scrolling the eye width gears G1 with one fixed eye height gear. Alternatively stated, the adaptive equalizing module 230 sweeps the eye width gears G1 with one fixed eye height gear to execute the method shown in FIGS. 7A and 7B. The adaptive equalizing module 230 may start analyze one bit at any position of the error count data Errcnt. The start position may be, for example, the position 1. The adaptive equalizing module 230 continuous analyzing the subsequent positions 2 to7, to calculate the matched position 620 (i.e., the position 3) with the output eye width gear DO1 and the output eye height gear DO2.

In a step S710, the adaptive equalizing module 230 initialize gear settings, and obtains the error count data Errcnt output from the decoder 220. Specifically, the settings of the eye width gear of the CTLE 211 and the settings of eye height gear of the slicer 212 are initialized. The adaptive equalizing module 230 waits the foresaid settings to be done, and wait the check time of the CDR 214 to be done. The decoder 220 checks and saves the counted error amount of the receiving signal D1 with reference to the correct bit data DRX, and outputs the error count data Errcnt accordingly.

In a step S721, the adaptive equalizing module 230 determines whether the error count data Errcnt includes bits changed from an error bit to a correct bit. When the determination in the step S721 is no, it represents that the bit of the error count data Errcnt stands outside or inside the frames 611 and 612, and the eye width gear and the eye height gear corresponding to such bit both are not edge gears of the frames 611 and 612. For example, regarding the position 1, the determination in the step S721 is no, and the adaptive equalizing module 230 continues executing a step S722.

On the other hand, when the determination in the step S721 is yes, it represents that the bit of the error count data Errcnt stands the leftmost frames 611 and 612, and the eye width gear corresponding to such bit is the edge gears of the frames 611 and 612, which is the minimum eye width gear with one corresponding eye height gear. For example, regarding the position 2, the determination in the step S721 is yes, and the adaptive equalizing module 230 continues executing a step S731. In a step S731, the adaptive equalizing module 230 sets the minimum eye width gear G1_MIN corresponding to the error bit in the step S721 of the eye width gears. The adaptive equalizing module 230 continues executing a step S730.

In a step S722, the adaptive equalizing module 230 determines whether the error count data Errcnt includes bits changed from the correct bit to the error bit. When the determination in the step S722 is no, it represents that the bit of the error count data Errcnt stands outside or inside the frames 611 and 612, and the eye width gear and the eye height gear corresponding to such bit both are not edge gears of the frames 611 and 612. For example, regarding the position 1, the determination in the step S721 is no, and the adaptive equalizing module 230 continues executing a step S730.

In a step S730, the adaptive equalizing module 230 analyzes the next eye width gear, and is back to execute the step S710, to wait and check the foresaid eye width gear to be set. The foresaid next eye width gear may be, for example, located at the position 2. As discussed above, regarding the position 2, the adaptive equalizing module 230 sets the minimum eye width gear G1_MIN in the step S731.

In this embodiment, a gap switched from the current eye width gear to the next eye width gear may be determined by requirement design. For example, the gap may be, for example, one unit of the eye width gear, or two or more units of the eye width gear.

Continuously, when the determination in the step S722 is yes, it represents that the bit of the error count data Errcnt stands the rightmost frames 611 and 612, and the eye width gear corresponding to such bit is the edge gears of the frames 611 and 612, which is the maximum eye width gear with one corresponding eye height gear. For example, regarding the position 4, the determination in the step S722 is yes, and the adaptive equalizing module 230 continues executing a step S732. In a step S732, the adaptive equalizing module 230 sets the maximum eye width gear G1_MAX corresponding to the correct bit in the step S722 of the eye width gears. The adaptive equalizing module 230 continues executing a step S741.

In a step S741, the adaptive equalizing module 230 determine whether the error count data Errcnt includes an edge bit corresponding to an end eye height gear of the eye height gears, or determine whether the minimum eye width gear G1_MIN with one corresponding eye height gear is equal to the maximum eye width gear G1_MAX with the same eye height gear. When the determination in the step S741 is no, it represents that the bit of the error count data Errcnt is not located at the top or bottom of the frames 611 and 612, and the eye width gear and the eye height gear corresponding to such bit both are not edge gears (e.g., top eye height gear or bottom eye height gear) of the frames 611 and 612. For example, regarding the position 4, the determination in the step S741 is no, and the adaptive equalizing module 230 continues executing a step S750.

In a step S750, the adaptive equalizing module 230 analyzes the next eye height gear, and is back to execute the step S730, to wait and check the foresaid eye height gear to be set. The foresaid next eye height gear may be, for example, located at the position 6. Regarding the position 6, the operations may be reference with the positions 1 to 5.

In this embodiment, a gap switched from the current eye height gear to the next eye height gear may be determined by requirement design. For example, the gap may be, for example, one unit of the eye height gear, or two or more units of the eye height gear.

Continuously, when the determination in the step S741 is yes, it represents that the bit of the error count data Errcnt is located at the top or bottom of the frames 611 and 612, and the eye width gear and the eye height gear corresponding to such bit both are one of the edge gears (e.g., top eye height gear or bottom eye height gear) of the frames 611 and 612. For example, regarding the position 7, the determination in the step S741 is yes, and the adaptive equalizing module 230 continues executing a step S742.

In a step S742, the adaptive equalizing module 230 determine whether the decoder 220 finishes sweeping the recovery signal data D1 corresponding to a positive half eye diagram (i.e., the frame 611) and a negative half eye diagram (i.e., the frame 612). When the determination in the step S742 is yes, it represents that the adaptive equalizing module 230 has analyzed all bits of the error count data Errcnt, and the adaptive equalizing module 230 continues executing a step S761. Otherwise, the adaptive equalizing module 230 executing a step S762.

In detail, in the step S742, the adaptive equalizing module 230 determine whether the analysis of the bits of the error count data Errcnt corresponding to the positive half eye diagram (i.e., the frame 611) is done. When the foresaid determination is no, it represents the sweeping analysis of such positive frame 611 has already been done, and it further represents the sweeping analysis of the negative frame 612 is currently done. As such, the adaptive equalizing module 230 sets and saves the minimum eye height gear G2_MIN of the eye height gears. On the other hands, when the foresaid determination is yes, it represents the sweeping analysis of the positive frame 611 is currently done. As such, the adaptive equalizing module 230 sets the maximum eye height gear G2_MAX of the eye height gears.

Then, in the step S742, the adaptive equalizing module 230 determine whether the analysis of the bits of the error count data Errcnt corresponding to the positive half eye diagram (i.e., the frame 611) and the negative half eye diagram (i.e., the frame 612) are both done. When the foresaid determination is no, it represents the sweeping analysis of one side (e.g., the negative frame 612) have not been done. For example, regarding the position 7, the foresaid determination in the step S742 is no, and the adaptive equalizing module 230 continues executing a step S762. Otherwise, it represents the sweeping analysis of both side (e.g., the positive frame 611 and the negative frame 612) have been done.

In a step S762, the adaptive equalizing module 230 saves the maximum eye height gear G2_MAX with one corresponding eye width gear, and changes sides from the positive frame 611 to the negative frame 612. The adaptive equalizing module 230 is back to execute the step S710 for the analysis of the negative half eye diagram.

In a step S761, the adaptive equalizing module 230 calculates an average value of the minimum eye width gear G1_MIN and the maximum eye width gear G1_MAX to generate the output eye width gear DO1. The adaptive equalizing module 230 calculates an average value of the minimum eye height gear G2_MIN and the maximum eye height gear G2_MAX to generate the output eye height gear DO2.

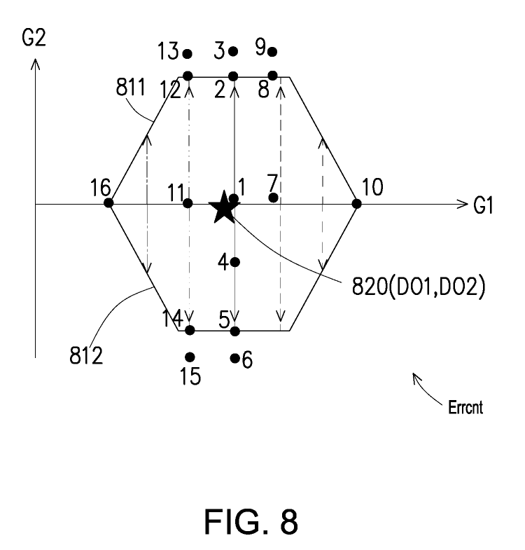

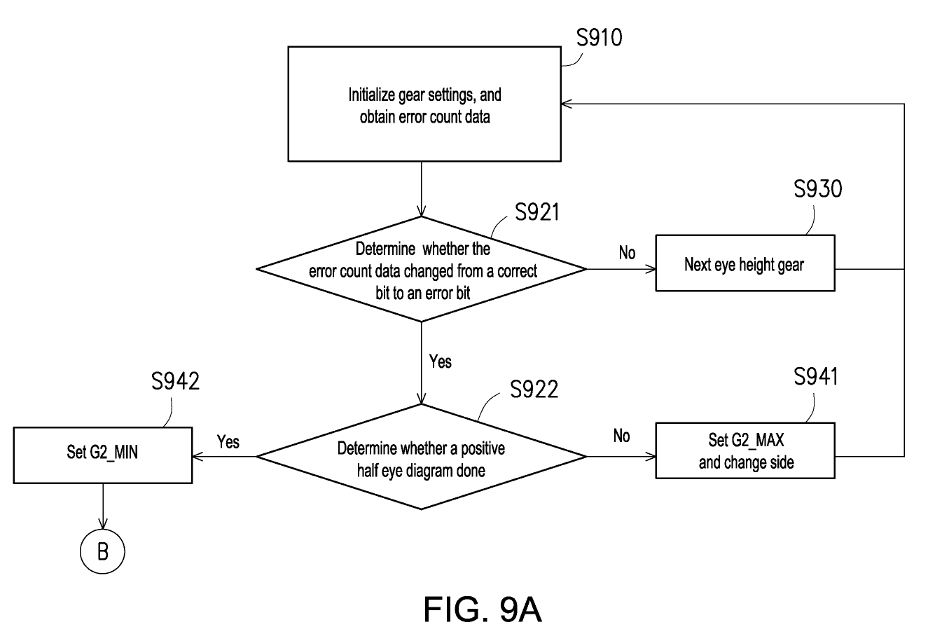

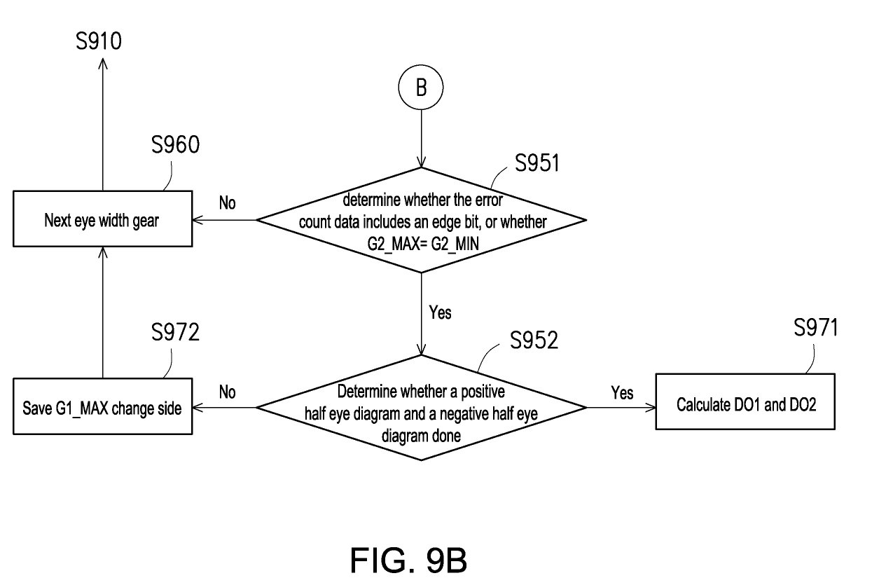

FIG. 8 is a schematic diagram of operations of an adaptive equalizing module according to the embodiment of FIG. 2 of the disclosure. FIGS. 9A and 9B are flow charts of an operating method of the adaptive equalizing module according to the embodiment of FIG. 8 of the disclosure. Referring to FIGS. 2, 6, 7A, 7B, the adaptive equalizer 200 executes steps S910 to S972 through the adaptive equalizing module 230 to calculate the output gears DO1 and DO2. In FIG. 8, the error count data Errcnt is exemplarily illustrated, with the x-axis reference to the eye width gears G1 and the y-axis reference to the eye height gears G2. The bits inside two frames 811 and 812 are assumed to be correct data bits which are equalized by the equalizing circuit 210. The bits outside the frames 811 and 812 are assumed to be error data bits which are equalized by the equalizing circuit 210.

In this embodiment, the adaptive equalizing module 230 analyzes the error count data Errcnt by scrolling the eye height gears G2 with one fixed eye width gear. Alternatively stated, the adaptive equalizing module 230 sweeps the eye height gears G2 with one fixed eye width gear to execute the method shown in FIGS. 9A and 9B. The adaptive equalizing module 230 may start analyze one bit at any position of the error count data Errcnt. The start position may be, for example, the position 1. The adaptive equalizing module 230 continuous analyzing the subsequent positions 2 to 10 and 11 to 16, to calculate the matched position 820 with the output eye width gear DO1 and the output eye height gear DO2.

In a step S910, the adaptive equalizing module 230 initialize gear settings, and obtains the error count data Errcnt output from the decoder 220. The step S910 may be reference to the step S710.

In a step S921, the adaptive equalizing module 230 determines whether the error count data Errcnt includes bits changed from an error bit to a correct bit. When the determination in the step S721 is no, it represents that the bit of the error count data Errcnt stands outside or inside the frames 811 and 812, and the eye width gear and the eye height gear corresponding to such bit both are not edge gears of the frame 811 and 812. For example, regarding the position 1, the determination in the step S921 is no, and the adaptive equalizing module 230 continues executing a step S930.

In a step S930, the adaptive equalizing module 230 analyzes the next eye height gear, and is back to execute the step S910, to wait and check the foresaid eye height gear to be set. The foresaid next eye height gear may be, for example, located at the position 2.

In this embodiment, a gap switched from the current eye height gear to the next eye height gear may be determined by requirement design. For example, the gap may be, for example, one unit of the eye height gear, or two or more units of the eye height gear.

With the positive determination in the step S921, the correct bit of the error count data Errcnt is located at the top or bottom of the frames 811 and 812, and the eye width gear and the eye height gear corresponding to such bit both are one of the edge gears (e.g., top eye height gear or bottom eye height gear) of the frames 811 and 812. For example, regarding the position 2, the determination in the step S921 is yes, and the adaptive equalizing module 230 continues executing a step S922.

In a step S922, when the error count data Errcnt includes bits changed from the correct bit to the error bit, the adaptive equalizing module 230 determines whether the decoder 220 finishes sweeping the recovery signal data D1 corresponding to the positive half eye diagram (i.e., right side of the frame 811). When the determination in the step S922 is no, it represents that the sweeping analysis of such side of the positive frame 811 has already been done, and it further represents the sweeping analysis of the same side of the negative frame 812 has not been done. For example, regarding the position 2, the foresaid determination in the step S922 is no, and the adaptive equalizing module 230 continues executing a step S941.

In a step S941, the adaptive equalizing module 230 sets and saves the maximum eye height gear G2_MAX corresponding to the correct bit in the step S921 of the eye height gears with one corresponding eye width gear. The adaptive equalizing module 230 changes sides from the positive frame 811 to the negative frame 812. The adaptive equalizing module 230 is back to execute the step S910 for the analysis of the negative half eye diagram.

On the other hands, when the determination in the step S922 is yes, it represents the sweeping analysis of the such side of the positive frame 811 is done currently. For example, regarding the position 5, the determination in the step S921 is yes and the determination in the step S922 is also yes. The adaptive equalizing module 230 continues executing a step S942.

In a step S942, the adaptive equalizing module 230 sets and saves a minimum eye height gear G2_MIN corresponding to the correct bit in the step S921 of the eye height gears with one corresponding eye width gear. For example, regarding the position 5, the determination in the step S921 is yes and the determination in the step S922 is no. The adaptive equalizing module 230 continues executing a step S951.

In a step S951, the adaptive equalizing module 230 determine whether the error count data Errcnt includes an edge bit corresponding to an end eye width gear of the width gears, or determine whether the minimum eye height gear G2_MIN with one corresponding eye width gear is equal to the maximum eye height gear G2_MAX with one corresponding eye width gear. When the determination in the step S951 is no, it represents that the bit of the error count data Errcnt does not stands the rightmost frames 811 and 812. For the position 6, the determination in the step S951 is no, and the adaptive equalizing module 230 continues executing a step S960.

In a step S960, the adaptive equalizing module 230 analyzes the next eye width gear, and is back to execute the step S910, to wait and check the foresaid eye width gear to be set. The foresaid next eye width gear may be, for example, located at the position 7. Regarding the position 7, the operations may be reference with the positions 1 to 6.

In this embodiment, a gap switched from the current eye width gear to the next eye width gear may be determined by requirement design. For example, the gap may be, for example, one unit of the eye width gear, or two or more units of the eye width gear.

Continuously, when the determination in the step S951 is yes, it represents that the bit of the error count data Errcnt stands the rightmost frames 811 and 812. For the position 10, the determination in the step S951 is yes, and the adaptive equalizing module 230 continues executing a step S952.

In a step S952, the adaptive equalizing module 230 determine whether the decoder 220 finishes sweeping the recovery signal data D1 corresponding to a positive half eye diagram (i.e., the frame 811) and a negative half eye diagram (i.e., the frame 812). When the determination in the step S952 is yes, it represents that the adaptive equalizing module 230 has analyzed all bits of the error count data Errcnt, and the adaptive equalizing module 230 continues executing a step S971. Otherwise, the adaptive equalizing module 230 executing a step S972.

In detail, in the step S952, the adaptive equalizing module 230 determine whether the analysis of the bits of the error count data Errcnt corresponding to the first positive half eye diagram (i.e., right side of the frames 811 and 812) is done. When the foresaid determination is no, it represents the sweeping analysis of such part (i.e., the right side of the frames 811 and 812) has already been done, and it further represents the sweeping analysis of the first negative half eye diagram (i.e., left side of the frames 811 and 812) is currently done. As such, the adaptive equalizing module 230 sets and saves the maximum eye width gear G1_MAX of the eye width gears. On the other hands, when the foresaid determination is yes, it represents the sweeping analysis of such part (i.e., the left side of the frames 811 and 812) is currently done. As such, the adaptive equalizing module 230 sets and saves the minimum eye width gear G1_MIN of the eye width gears.

Then, in the step S952, the adaptive equalizing module 230 determine whether the analysis of the bits of the error count data Errcnt corresponding to the second positive half eye diagram (i.e., the frame 811) and the second negative half eye diagram (i.e., the frame 812) are both done. When the foresaid determination is no, it represents the sweeping analysis of one side (e.g., the frame 812) have not been done. For example, regarding the position 10, the foresaid determination in the step S952 is no, and the adaptive equalizing module 230 continues executing a step S972. Otherwise, it represents the sweeping analysis of both side (e.g., the frames 811 and 812) have been done. For example, regarding the position 16, the foresaid determination in the step S952 is yes, and the adaptive equalizing module 230 executes a step S971.

In a step S972, the adaptive equalizing module 230 saves the maximum eye width gear G1_MAX with one corresponding eye width gear, and changes sides from the right side of the frames 811 and 812 to the left side of the frames 811 and 812. The adaptive equalizing module 230 is back to execute the step S910 for the analysis of the second negative half eye diagram (i.e., the left side of the frames 811 and 812).

In the step S971, the adaptive equalizing module 230 calculates an average value of the minimum eye width gear G1_MIN and the maximum eye width gear G1_MAX to generate the output eye width gear DO1. The adaptive equalizing module 230 calculates an average value of the minimum eye height gear G2_MIN and the maximum eye height gear G2_MAX to generate the output eye height gear DO2.

To sum up, in the adaptive equalizer and the operation method thereof of the embodiments of the disclosure, by decoding and counting error decoded bits of the recovery signal data through the decoder, the error count data includes correct bits and error bits and may be reference with the eye width gears and the eye height gears. By analyzing the error count data in a sweeping way through the adaptive equalizing module, the adaptive equalizer is capable of calculating the reasonable eye width gear and the eye height gear as the output matched gear for the functional gain difference and the decision threshold. Therefore, the adaptive equalizer is capable of automatically and accurately obtaining the matched gear, and further improves the efficiency of gear setting for compensating the channel loss.

It will be apparent to those skilled in the art that various modifications and variations can be made to the disclosed embodiments without departing from the scope or spirit of the disclosure. In view of the foregoing, it is intended that the disclosure covers modifications and variations provided that they fall within the scope of the following claims and their equivalents.

What is claimed is:

1. An adaptive equalizer, comprising:
an equalizing circuit, configured to, based on a plurality of eye width gears and a plurality of eye height gears, generate recovery signal data according to a receiving signal;
a decoder, coupled to the equalizing circuit, and configured to generate error count data according to the recovery signal data and correct bit data corresponding to the receiving signal; and
an adaptive equalizing module, coupled to the decoder and the equalizing circuit, and configured to generate an output eye width gear and an output eye height gear according to the error count data, such that the equalizing circuit compensates channel loss based on the output eye width gear and the output eye height gear.

2. The adaptive equalizer according to claim 1, wherein the adaptive equalizing module is configured to:
sweep the recovery signal data corresponding to the plurality of eye width gears with each one of the plurality of eye height gears, to generate the output eye width gear and the output eye height gear; or
sweep the recovery signal data corresponding to the plurality of eye height gears with each one of the plurality of eye width gears, to generate the output eye width gear and the output eye height gear.

3. The adaptive equalizer according to claim 1, wherein the adaptive equalizing module is configured to:
set a plurality of edge eye width gears of the plurality of eye width gears according to the error count data;
set a plurality of edge eye height gears of the plurality of eye height gears according to the error count data;
calculate the output eye width gear according to the plurality of edge eye width gears; and
calculate the output eye height gear according to the plurality of edge eye height gears.

4. The adaptive equalizer according to claim 1, wherein the adaptive equalizing module is configured to:
determine whether the error count data comprising bits changed from an error bit to a correct bit, to set a minimum eye width gear corresponding to the error bit of the plurality of eye width gears; and
determine whether the error count data comprising bits changed from the correct bit to the error bit, to set a maximum eye width gear corresponding to the correct bit of the plurality of eye width gears.

5. The adaptive equalizer according to claim 4, wherein the adaptive equalizing module is configured to:
determine whether the error count data comprising an edge bit corresponding to an end eye height gear of the plurality of eye height gears, or whether the minimum eye width gear is equal to the maximum eye width gear; and
determine whether the decoder finishes sweeping the recovery signal data corresponding to a positive half eye diagram and a negative half eye diagram, to set a minimum eye height gear and a maximum eye height gear of the plurality of eye height gears.

6. The adaptive equalizer according to claim 5, wherein the adaptive equalizing module is configured to:
calculate an average value of the minimum eye width gear and the maximum eye width gear to generate the output eye width gear; and
calculate an average value of the minimum eye height gear and the maximum eye height gear to generate the output eye height gear.

7. The adaptive equalizer according to claim 1, wherein the adaptive equalizing module is configured to:
when the error count data comprises bits changed from a correct bit to an error bit, determine whether the decoder finishes sweeping the recovery signal data corresponding to a positive half eye diagram, to set a maximum eye height gear corresponding to the correct bit of the plurality of eye height gears, or set a minimum eye height gear corresponding to the correct bit of the plurality of eye height gears.

8. The adaptive equalizer according to claim 7, wherein the adaptive equalizing module is configured to:
determine whether the error count data comprising an edge bit corresponding to an end eye width gear of the plurality of eye width gears, or whether the minimum eye height gear is equal to the maximum eye height gear; and
determine whether the decoder finishes sweeping the recovery signal data corresponding to a positive half eye diagram and a negative half eye diagram, to set a minimum eye width gear of the plurality of eye width gears, and to set a maximum eye width gear corresponding to the edge bit of the plurality of eye width gears.

9. The adaptive equalizer according to claim 8, wherein the adaptive equalizing module is configured to:
calculate an average value of the minimum eye width gear and the maximum eye width gear to generate the output eye width gear; and
calculate an average value of the minimum eye height gear and the maximum eye height gear to generate the output eye height gear.

10. The adaptive equalizer according to claim 1, wherein the equalizing circuit comprising:
a continuous-time linear equalizer (CTLE), coupled to the adaptive equalizing module, and configured to receive the output eye width gear and the receiving signal;
a slicer, coupled to the CTLE;
an offset circuit, coupled to the slicer and the adaptive equalizing module, and configured to receive the output eye height gear; and
a clock and data recovery (CDR) circuit, coupled to the slicer and the decoder.

11. An operating method of an adaptive equalizer, comprising:
based on a plurality of eye width gears and a plurality of eye height gears, generating, by an equalizing circuit, recovery signal data according to a receiving signal;
generating, by a decoder, error count data according to the recovery signal data and correct bit data corresponding to the receiving signal; and
generating, by an adaptive equalizing module, an output eye width gear and an output eye height gear according to the error count data, such that the equalizing circuit compensates channel loss based on the output eye width gear and the output eye height gear.

12. The operating method according to claim 11, wherein the generating the output eye width gear and the output eye height gear according to the error count data comprising:
sweeping, by the adaptive equalizing module, the recovery signal data corresponding to the plurality of eye width gears with each one of the plurality of eye height gears, to generate the output eye width gear and the output eye height gear; or
sweeping, by the adaptive equalizing module, the recovery signal data corresponding to the plurality of eye height gears with each one of the plurality of eye width gears, to generate the output eye width gear and the output eye height gear.

13. The operating method according to claim 11, wherein the generating the output eye width gear and the output eye height gear according to the error count data comprising:
setting, by the adaptive equalizing module, a plurality of edge eye width gears of the plurality of eye width gears according to the error count data;
setting, by the adaptive equalizing module, a plurality of edge eye height gears of the plurality of eye height gears according to the error count data;
calculating, by the adaptive equalizing module, the output eye width gear according to the plurality of edge eye width gears; and
calculating, by the adaptive equalizing module, the output eye height gear according to the plurality of edge eye height gears.

14. The operating method according to claim 11, wherein the generating the output eye width gear and the output eye height gear according to the error count data comprises:
determining, by the adaptive equalizing module, whether the error count data comprising bits changed from an error bit to a correct bit, to set a minimum eye width gear corresponding to the error bit of the plurality of eye width gears; and
determining, by the adaptive equalizing module, whether the error count data comprising bits changed from the correct bit to the error bit, to set a maximum eye width gear corresponding to the correct bit of the plurality of eye width gears.

15. The operating method according to claim 14, wherein the generating the output eye width gear and the output eye height gear according to the error count data further comprises:
determining, by the adaptive equalizing module, whether the error count data comprising an edge bit corresponding to an end eye height gear of the plurality of eye height gears, or whether the minimum eye width gear is equal to the maximum eye width gear; and
determining, by the adaptive equalizing module, whether the decoder finishes sweeping the recovery signal data corresponding to a positive half eye diagram and a negative half eye diagram, to set a minimum eye height gear and a maximum eye height gear of the plurality of eye height gears.

16. The operating method according to claim 15, wherein the generating the output eye width gear and the output eye height gear according to the error count data further comprises:
calculating, by the adaptive equalizing module, an average value of the minimum eye width gear and the maximum eye width gear to generate the output eye width gear; and
calculating, by the adaptive equalizing module, an average value of the minimum eye height gear and the maximum eye height gear to generate the output eye height gear.

17. The operating method according to claim 11, wherein the generating the output eye width gear and the output eye height gear according to the error count data comprises:
when the error count data comprises bits changed from a correct bit to an error bit, determining, by the adaptive equalizing module, whether the decoder finishes sweeping the recovery signal data corresponding to a positive half eye diagram, to set a maximum eye height gear corresponding to the correct bit of the plurality of eye height gears, or set a minimum eye height gear corresponding to the correct bit of the plurality of eye height gears.

18. The operating method according to claim 17, wherein the generating the output eye width gear and the output eye height gear according to the error count data further comprises:
determining, by the adaptive equalizing module, whether the error count data comprising an edge bit corresponding to an end eye width gear of the plurality of eye width gears, or whether the minimum eye height gear is equal to the maximum eye height gear; and
determining, by the adaptive equalizing module, whether the decoder finishes sweeping the recovery signal data corresponding to a positive half eye diagram and a negative half eye diagram, to set a minimum eye width gear of the plurality of eye width gears, and to set a maximum eye width gear corresponding to the edge bit of the plurality of eye width gears.

19. The operating method according to claim 18, wherein the generating the output eye width gear and the output eye height gear according to the error count data further comprises:
calculating, by the adaptive equalizing module, an average value of the minimum eye width gear and the maximum eye width gear to generate the output eye width gear; and
calculating, by the adaptive equalizing module, an average value of the minimum eye height gear and the maximum eye height gear to generate the output eye height gear.
